(19) United States
(12) Patent Application Publication
(10) Pub. No.: US 2010/0110283 A1
(43) Pub. Date: May 6, 2010

(54) CAMERA LENS MODULE-INTEGRATED SPEAKER ASSEMBLY

(75) Inventor: Doo-Sik SHIN, Suwon-si (KR)

Correspondence Address: THE FARRELL LAW FIRM, LLP, 290 Broadhollow Road, Suite 210E, Melville, NY, 11747, US

(73) Assignee: Samsung Electronics Co., Ltd.

(21) Appl. No.: 12/606,783

(22) Filed: Oct. 27, 2009

(30) Foreign Application Priority Data
Oct. 30, 2008 (KR) 10-2008-0107315

(51) Int. Cl. H04N 5/225; H04R 1/02

(52) U.S. Cl. 348/374; 348/E05.024; 381/386

(57) ABSTRACT

A camera lens module-integrated speaker assembly is provided, which includes a speaker housing, a camera lens module mounted through a center of the speaker housing, and a speaker module surrounding the camera lens module along an outer circumference of the camera lens module.

### PRIORITY

This application claims priority under 35 U.S.C. §119(a) of a Korean Patent Application filed in the Korean Intellectual Property Office on Oct. 30, 2008 and assigned Serial No. 2008-107315, the entire disclosure of which is incorporated herein by reference.

### BACKGROUND OF THE INVENTION

1. Field of the Invention

The present invention generally relates to a camera lens module-integrated speaker assembly. More particularly, the present invention relates to a camera lens module-integrated speaker assembly having a camera lens module and a speaker module integrated in a speaker housing.

2. Description of the Related Art

The recent development of digital camera fabrication technology is a driving force behind small, lightweight camera lens assemblies. Thus a camera can be mounted in a mobile terminal and mobile terminals equipped with an optical lens and a camera device have become popular. At the early development stage of a mobile terminal with a camera, the performance of cameras included in mobile terminals was much lower than that of commercial digital cameras (not included in mobile terminals) at that time. For example, a popular digital camera not included within a mobile terminal may have been capable to capturing an image with 4 million pixels, while a camera equipped in a mobile terminal may have typically captured only 30 thousand pixels at that time of early development. Even a camera equipped in a premium mobile terminal was not capable of capturing more than 1 million pixels for a single image. Recently, 1 million-pixel cameras have become more commonly provided in mobile terminals. For a premium mobile terminal, an included camera may capture as many pixels per image as popular digital cameras not included within a mobile terminal, for example, 3 million pixels. Also, mobile terminals with cameras that captures 7 or more million-pixels per image have been successfully commercialized. The improvement of the camera function of mobile terminals is attributed to an increased precision in the technology for fabricating a camera lens assembly. A structure of the camera lens assembly is disclosed in U.S. Patent Application Publication No. 2008-0253003 (filed Apr. 10, 2008) and commonly assigned to the present assignee. A camera module is typically provided on the front or rear surface of a mobile terminal so as to capture an image. In a typical sliding-type terminal, the camera module is inside the terminal and, for image capturing, the camera is exposed by a sliding operation. Today, camera lens modules are provided on the front and rear surfaces of a portable terminal, and an interactive video call may be conducted through a camera lens module on the front surface of the mobile terminal, on which a display is also provided. The front-surface camera lens module for video calls may also be able to capture image, or a second camera lens may be separately provided on the rear surface of the mobile terminal for image capturing.

FIG. 1 illustrates an inner engagement state of a conventional portable terminal with a camera lens module and a speaker module on a front surface thereof and FIG. 2 illustrates the exterior of the conventional portable terminal of FIG. 1. Referring to FIGS. 1 and 2, a portable terminal 10 is provided, on a front surface thereof, with a speaker module 13 for transmission and reception in an upper portion of a body housing 11 and a microphone module 14 in a lower portion of the body housing 11. A display 12 is interposed between the speaker module 13 and the microphone module 14. The speaker module 13 is provided in a speaker hole 11a of the body housing 10. A camera lens module 15 is provided on a side of the speaker module 13 such that the camera lens module 15 is close to the speaker module 13, in misalignment with the center of the body housing 11.

As illustrated in FIG. 1, the speaker module 13 for transferring voice and the camera module 15 are alongside in the upper portion of the body housing 11. That is, the speaker module 13 and the camera lens module 15 occupy their own spaces within the body housing 11. As a result, the speaker module 13 and the camera lens module 15 make it difficult to utilize space in a slim portable terminal 10. The speaker module 13 and the camera lens module 15 are also an obstacle to creating a small and lightweight terminal. Moreover, as the speaker module 13 and the camera lens module 15 are separately mounted on a Printed Circuit Board (PCB), the assembly process of the mobile terminal 10 is complex, which increases the cost of the mobile terminal 10. Referring to FIG. 2, the speaker module 13 is positioned in the speaker hole 11a at the center of the body housing 11 and the camera lens module 15 is neighboring to the speaker module in an upper portion of the portable terminal 10.

Therefore, the speaker module 13 and the camera lens module 15 both appear on the top surface of the portable terminal 10, harming the outward aesthetic appearance of the portable terminal 10. In general, the speaker module 13 is positioned at an upper center of the body housing 11 and the camera lens module 15 is misaligned with the center of the body housing 11. Thus, when a user conducts a video call or takes a photograph, the user or an object to be photographed is captured in misalignment to one side. The resulting gap between the captured image and the user or the object on a display of the user or the other party causes a feeling of unbalance to the user. The user must inconveniently re-position the camera lens module 15 to compensate for the misalignment, when the user takes a photograph.

Accordingly, there is a need for an apparatus having a camera module and a speaker module integrated with each other to save installation space and reduce cost through a simplified assembly process. There is also a need for an apparatus having a camera module and a speaker module integrated with each other, in which the camera lens module is at the center of a body housing to prevent an object from being captured in misalignment to one side, and enables photographing and transmission of a better-quality image to another party.

### SUMMARY OF THE INVENTION

An aspect of the present invention is to address at least the problems and/or disadvantages and to provide at least the advantages described below. Accordingly, an aspect of embodiments of the present invention provides a camera lens module-integrated speaker assembly having a speaker module and a camera lens module integrated in a single housing in a portable terminal.

Another aspect of embodiments of the present invention provides a camera lens module-integrated speaker assembly having a camera lens module within a speaker module, to be positioned at the center of a body housing to thereby enhance the outward appearance of the body housing.

A further aspect of embodiments of the present invention provides a camera lens module-integrated speaker assembly having a camera lens module within a speaker module, to be positioned at the center of a body housing, thereby enabling accurate image capturing, facilitating video calling or image capturing compared to a conventional lens module, and allowing transmission of a better-quality image to the other party.

In accordance with an aspect of embodiments of the present invention, there is provided a camera lens module-integrated speaker assembly in which there is a speaker housing, a camera lens module mounted through a center of the speaker housing, and a speaker module surrounds the camera lens module along an outer circumference of the camera lens module.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 is a view illustrating an inner engagement state of a camera lens module and a speaker module in a conventional portable terminal;

FIG. 2 is a view illustrating the exterior of the conventional portable terminal of FIG. 1;

FIG. 3 is an exploded perspective view of a camera lens module-integrated speaker assembly according to an embodiment of the present invention;

FIG. 4 is an assembled perspective view of the camera lens module-integrated speaker assembly according to the embodiment of the present invention;

FIG. 5 is a sectional view of the camera lens module-integrated speaker assembly illustrated in FIG. 4, taken along line A-A′; and

FIG. 6 illustrates the exterior of a portable terminal with the camera lens module-integrated speaker assembly installed according to an embodiment of the present invention.

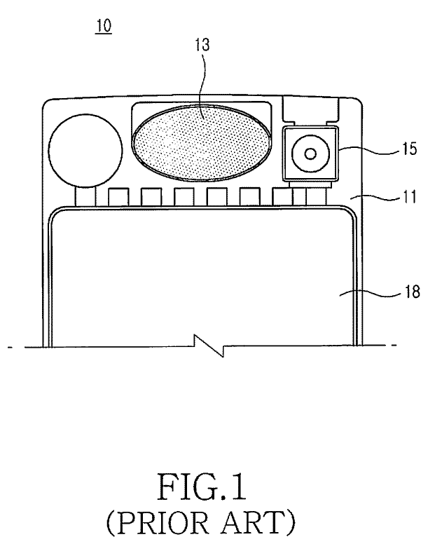

Throughout the drawings, the same drawing reference numerals will be understood to refer to the same elements, features and structures.

### DETAILED DESCRIPTION OF EMBODIMENTS

The matters defined in the description such as a detailed construction and elements are provided to assist in a comprehensive understanding of embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

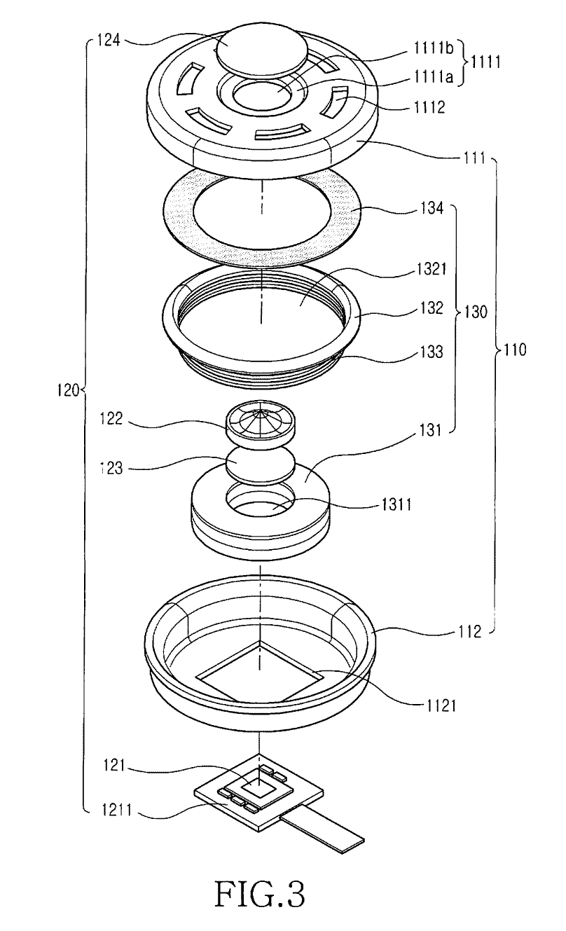

Referring to FIGS. 3, 4 and 5, a camera lens module-integrated speaker assembly 100 according to an exemplary embodiment of the present invention includes a speaker housing 110, a camera lens module 120, and a speaker module 130. The camera lens module 120 is provided at the center of the speaker housing 110 so that the camera lens module 120 is installed through the center of the speaker housing 110. The speaker module 130 is provided inside the speaker housing 110 so that the speaker module 130 may surround the camera lens module 120 along the outer circumference of the camera lens module 120.

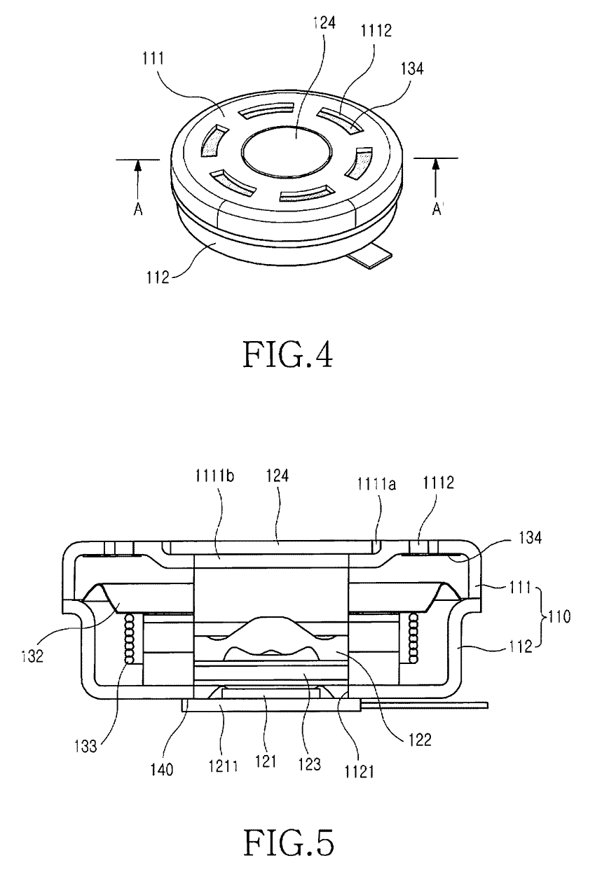

Referring to FIGS. 3 and 4, the speaker housing 110 includes a top frame 111 and a bottom frame 112 to be engaged with the top frame 111. The speaker module 130 resides within the engaged top and bottom frames 111 and 112. The speaker housing 110 and the speaker module 130 are hollow at their respective centers to accommodate the camera lens module 120.

A mount portion 1111 is provided on the top frame 111. The mount portion 1111 passes through an upper center of the top frame 111 to allow a window 124 of the camera lens module 120 to be mounted therein. A sensor hole 1121 is formed into the bottom frame 112, passing through a bottom center of the bottom frame 112 to allow an image sensor portion 121 of the camera lens module 120 to installed therein.

Referring to FIGS. 3, 4 and 5, the mount portion 1111 includes a mount surface 1111a and a through hole 1111b. The mount surface 1111a is formed around the outer circumference of the through hole 1111b so that the window 124 may be mounted on the mount surface 1111a. The through hole 111b is at the center of the top frame 111 so that the window 124 may be inserted through the center of the top frame 111.

Referring to FIGS. 3 to 6, at least one sound well hole 112 is provided around the through hole 1111b, apart from the mount surface 1111a for emitting sound generated from the speaker module 130 outward.

Referring to FIGS. 3 and 4, the speaker module 120 includes a magnet portion 131, a coil portion 133, and a diaphragm 132. The magnet portion 131 is mounted within the bottom frame 112. A lens hole 1311 is formed into the magnet portion 131 at a position corresponding to the sensor hole 1121 of the bottom frame 112 so that a lens portion 122 and an InfraRed (IR) filter portion 123 of the camera lens module 120 may be inserted into the center of the lens hole 1311. The coil portion 133 is wound around the outer circumference of the magnet portion 131. The diaphragm 132 is mounted on the magnet portion 131 to generate sound in engagement with the coil portion 133. The diaphragm 132 has a hole 1321 engaged with the lens hole 1311.

Referring to FIGS. 3 to 6, a dust shield 134 is provided to the top frame 111. The dust shield 134 is engaged with a top inner side surface of the top frame 111 in order to prevent introduction of foreign materials into the speaker housing 110 through the sound well holes 1112.

Referring to FIGS. 3 and 4, the camera lens module 120 includes an image sensor portion 121, a lens portion 122, and an IR filter portion 123. The image sensor portion 121 is mounted on a Printed Circuit Board (PCB) 1211, for capturing an image of an object through the window 124 mounted on the mount portion 1111. The image sensor portion 121, which has been mounted on the PCB 1211, is inserted into the sensor hole 1121. At least one lens portion 122 is engagedly stacked in the lens hole 1311 of the magnet portion 131. The IR filter portion 123 is provided between the image sensor portion 121 and the lens portion 122. Preferably, the IR filter portion 123 is inserted into the lens hole 1311.

Referring to FIG. t, the image sensor portion 121 is mounted on the PCB 1211 and then the PCB 1211 is engaged with the bottom frame 112 such that the image sensor portion 121 is positioned in the sensor hole 1121 of the bottom frame 112.

The PCB 1211 may be attached to the bottom frame 112 by epoxy. Also, the PCB 1211 and the bottom frame 112 may be combined by UltraViolet (UV) epoxy, in a manner that adjusts the distance between the image sensor portion 121 and the lens portion 122, or they may be welded together.

Referring to FIGS. 3, 4 and 5, the camera lens module 120 is further provided with the window 124 mounted on the mount surface 1111a of the top frame 111, for protecting the lens portion 122 and introducing an external image to the image sensor 121 through the lens portion 122. While not shown, the window 124 is formed of transparent glass so that an image incident on the window 124 is captured by the image sensor portion 121 through the lens portion 122. Also, the window 124 may be formed of transparent plastic so that an image incident on the window 124 is captured by the image sensor portion 121 through the lens portion 122.

An operation of the camera lens module-integrated speaker assembly having the above-described configuration according to an exemplary embodiment of the present invention will be described in detail with reference to FIGS. 3 to 6.

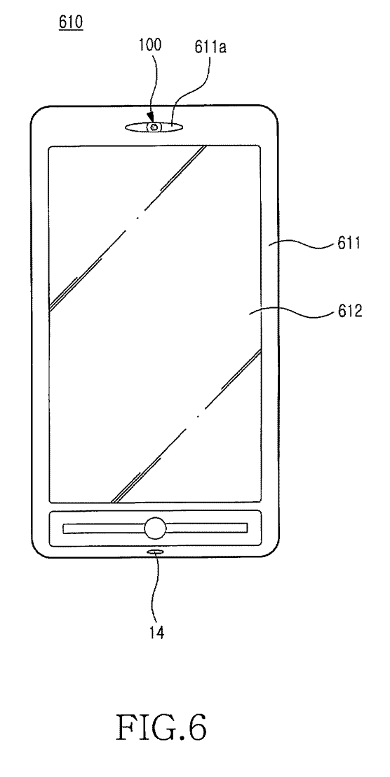

Referring to FIG. 6, the camera lens module-integrated speaker assembly 100 is installed at an upper center of the display in the portable terminal 610. In camera lens module-integrated speaker assembly 100, speaker module 130 is accommodated within the speaker housing 110. The speaker housing 110 and the speaker module 130 are donut-shaped, having the holes 1111b, 1321, 1311 and 1121 in this order at their centers, for allowing the camera lens module 120 to be inserted therethrough. More specifically, the speaker housing 110 includes the top frame 111 and the bottom frame 112. The top frame 111 is provided with the mount surface 1111a for mounting the window 124 of the camera lens module 120 thereon and the through hole 1111b for allowing an external object to be captured by the image sensor portion 121 through the window 124. The bottom frame 112 is fixed to the PCB 1211 electrically connected to a PCB (not shown) of the body housing 11 by epoxy, UV epoxy or welding. Also, the bottom frame 112 may be combined with the PCB 1211 in a manner that adjusts the distance between the image sensor portion 121 and the lens portion 122. The sensor hole 1121 is formed on the bottom frame 112, for engaging with the image sensor portion 121 mounted on the PCB 1211. As illustrated in FIG. 3, the sensor hole 1121 is preferably shaped into a square because the image sensor 121 inserted into the sensor hole 1121 is a square. Therefore, the window 124 and the image sensor portion 121 are inserted into the through hole 1111b and the sensor hole 1121 at the center of the top and bottom frames 111 and 112.

Referring to FIGS. 3 and 5, the holes 1111b, 1321, 1311 and 1121 are formed so that the camera lens module 130 resides at the center of the speaker module 130. The donut-shaped magnet portion 131 with the lens hole 1311 into which the lens portion 122 is inserted is provided within the bottom frame 112. The magnet portion 131 is preferably a permanent magnet.

The lens hole 1311 and the sensor hole 1121 communicate with each other. Therefore, an image of an object may be captured by the image sensor portion 121 through the lens portion 122 mounted in the lens hole 1311. Also, the coil portion 133 is wound around the magnet portion 131 between the inner circumference of the bottom frame 112 and the outer circumference of the magnet portion 131, for generating sound onto the diaphragm 132. The coil portion 133 is connected to the diaphragm 132 mounted on the magnet portion 131. The diaphragm 132 is also shaped into a donut, having the hole 1321 at its center. When current flows in the coil portion 133, the diaphragm 132 vibrates and thus generates sound. The sound well holes 1112 are formed in the top frame 111 in order to emit the sound generated by the diaphragm 132 outward. The dust shield 134 is formed to prevent introduction of foreign materials into the speaker housing 110 through the sound well holes 1112 of the top frame 111. The dust shield 134 is preferably donut-shaped. The lens portion 122 of the camera lens module 120 may be positioned anywhere between the through hole 111b of the speaker module 130 and the sensor hole 1121, preferably mounted in the lens hole 1311 of the magnet portion 131. Also, the IR filter portion 123 is installed between the lens portion 122 and the image sensor portion 121. Therefore, it is preferred that the IR filter 123 is also mounted in the lens hole 1311 of the magnet portion 131. Accordingly, the camera lens module 120 is integrated at the center of the speaker module 130.

As illustrated in FIG. 6, the camera lens module-integrated speaker assembly 100 is provided at an installation position of the speaker module 130 of the portable terminal 610. Hence, the camera lens module 120 is positioned at the center of the portable terminal 610 above a display 12 formed on the front surface of the portable terminal 610, so as to capture an object from the center of the portable terminal 610. Also, as the speaker module 130 is around the camera lens module 120, it emits sound outward from the portable terminal 610.

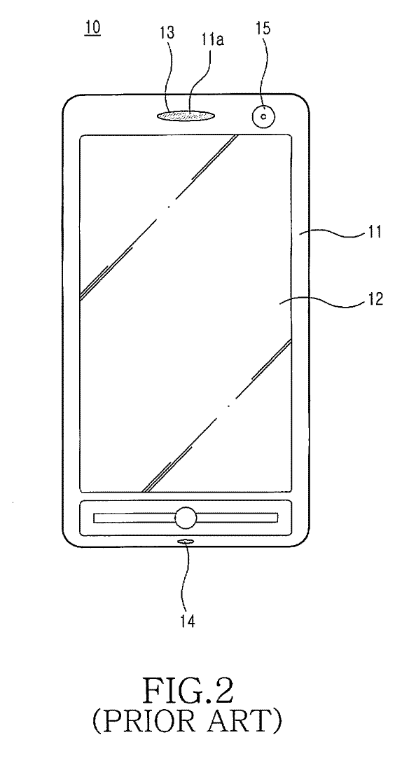

Therefore, when a video call is conducted through the portable terminal 610, a user or an object is captured, by the camera lens module 120, without misalignment to one side, thus enabling transmission of an aligned image to the other party. While conventionally the camera lens module is positioned at one side away from the center in the portable terminal 10 as illustrated in FIG. 2, the camera lens module-integrated speaker assembly 100 is in the speaker hole 611a of the body housing 611 in the present invention, thereby rendering balanced aesthetic of the portable terminal 610. Since both the camera lens module 120 and the speaker module 130 are provided in the single speaker housing 110, installation space is reduced and a more slim and lightweight portable terminal can be produced.

As is apparent from the above description, since a camera lens module is integrated in a speaker module in the camera lens module-integrated speaker assembly of the present invention, installation space is reduced for the camera lens module, and thus a slim portable terminal can be produced. Also, the speaker module with the camera lens module integrated therein is positioned at the center of a body housing, thereby allowing the portable terminal to appear more sophisticated. Compared to a conventional camera lens module positioned at one side away from a center of a body housing, the camera lens module of the present invention can produce a better-quality image. Hence, the present invention enables photographing and transmission of high-quality images to other parties. Due to the integration of the camera lens module and the speaker module, an assembly process is simplified and an assembly time is shortened.

The above embodiments of the present invention and the drawings as described above do not limit the camera lens module-integrated speaker assembly of the present invention, and many replacements, modifications, and changes can be made within the scope and spirit of the present invention. For example, while a single lens portion is shown in the present invention, the number of lens portions is not restricted. Also, although the through hole is square-shaped according to an embodiment of the present invention, any other shape is available such that the image sensor portion can be mounted in the through hole. While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. A camera lens module-integrated speaker assembly comprising:
a speaker housing;
a camera lens module mounted through a center of the speaker housing; and
a speaker module surrounding the camera lens module, along an outer circumference of the camera lens module.

2. The camera lens module-integrated speaker assembly of claim 1, wherein the speaker housing includes a top frame and a bottom frame combined with the top frame,
wherein the speaker module is mounted within the engaged top and bottom frames, and
wherein the camera lens module is provided through the center of the speaker housing with the speaker module.

3. The camera lens module-integrated speaker assembly of claim 2, wherein the top frame includes a mount portion formed through a top center of the top frame, for mounting a window of the camera lens module thereon, and a sensor hole formed through a bottom center of the bottom frame, for allowing an image sensor portion of the camera lens module to be inserted therethrough.

4. The camera lens module-integrated speaker assembly of claim 3, wherein the mount portion includes a mount surface for mounting the window thereon and a through hole formed through the center of the top frame, for allowing the window to be inserted therethrough.

5. The camera lens module-integrated speaker assembly of claim 4, wherein the top frame further includes at least one sound well hole formed around the through hole on a top surface of the top frame, for emitting sound generated from the speaker module outward.

6. The camera lens module-integrated speaker assembly of claim 5, wherein the speaker module includes a magnet portion provided in the bottom frame and having a lens hole formed at a center thereof, a coil portion wound around the magnet portion, and a diaphragm having a hole communicating with the lens hold and connected to the coil portion, for generating sound.

7. The camera lens module-integrated speaker assembly of claim 6, wherein the top frame further includes a dust shield engaged with an upper inner surface of the top frame, for preventing introduction of foreign materials into the speaker housing through the at least one sound well hole.

8. The camera lens module-integrated speaker assembly of claim 7, wherein the camera lens module includes the image sensor portion mounted in the sensor hole on a printed circuit board, for capturing an image, at least one lens portion provided in the lens hole of the magnet portion, and an InfraRed (IR) filter portion between the image sensor portion and the at least one lens portion.

9. The camera lens module-integrated speaker assembly of claim 8, wherein the printed circuit board is combined with the image sensor portion in the sensor hole by epoxy.

10. The camera lens module-integrated speaker assembly of claim 8, wherein the printed circuit board is combined with the image sensor portion in the sensor hole by UltraViolet (UV) epoxy, after a distance between the image sensor portion and the at least one lens portion is adjusted.

11. The camera lens module-integrated speaker assembly of claim 8, wherein the printed circuit board is combined with the image sensor portion in the sensor hole by welding, after a distance between the image sensor portion and the at least one lens portion is adjusted.

12. The camera lens module-integrated speaker assembly of claim 8, wherein the camera lens module further includes the window on the mount surface of the top frame, for protecting the at least one lens portion and introducing an external image into the image sensor portion through the at least one lens portion.

13. The camera lens module-integrated speaker assembly of claim 12, wherein the window is formed of transparent glass, for capturing an image incident on the window by the image sensor portion through the at least one lens portion.

14. The camera lens module-integrated speaker assembly of claim 12, wherein the window is formed of transparent plastic, for capturing an image incident on the window by the image sensor portion through the at least one lens portion.
